(19) United States
(12) Patent Application Publication
(10) Pub. No.: US 2021/0372484 A1
(43) Pub. Date: Dec. 2, 2021

(54) FREEWHEEL-DAMPER ASSEMBLY FOR A MOTOR VEHICLE AND DRIVETRAIN FOR A MOTOR VEHICLE HAVING SUCH A FREEWHEEL-DAMPER ASSEMBLY

(71) Applicant: BorgWarner Inc., Auburn Hills, MI (US)

(72) Inventor: Jochen Bölling, Baden-Baden (DE)

(21) Appl. No.: 17/303,433

(22) Filed: May 28, 2021

(30) Foreign Application Priority Data
May 29, 2020 (DE) 102020003256.7
Mar. 25, 2021 (DE) 102021001571.1

(51) Int. Cl. F16D 3/12; F16D 41/064; F16F 15/123; F02N 11/00

(52) U.S. Cl. CPC F16D 3/12; F16D 41/064; F16F 2236/08; F02N 11/003; F16F 2232/02; F16F 15/123

(57) ABSTRACT

The present invention relates to a freewheel-damper assembly (2) for a motor vehicle, having a torsional vibration damper (18) with a primary element (20) which is connectible or connected, on a drive side (36) of the torsional vibration damper (18), to a drive shaft (38), and with a secondary element (22) which is torsionally elastically coupled to the primary element (20) and which is connectible or connected, on an output side (46) of the torsional vibration damper (18) facing away from the drive side (36), to a transmission input shaft (48), and with a starter freewheel (58), via which the primary element (20) can be indirectly or directly driven by a starter motor (60). The starter freewheel (58) is arranged on the output side (46) of the torsional vibration damper (18). The present invention moreover relates to a drivetrain for a motor vehicle having such a freewheel-damper assembly (2).

### CROSS-REFERENCE TO RELATED APPLICATIONS

This application claims priority pursuant to 35 U.S.C. 119(a) of German Patent Application No. 102020003256.7 filed May 29, 2020, and German Patent Application No. 102021001571.1 filed Mar. 25, 2021, which applications are herein incorporated by reference in the entirety.

### SUMMARY

The present invention relates to a freewheel-damper assembly for a motor vehicle, having a torsional vibration damper with a primary element which is connectible or connected, on a drive side of the torsional vibration damper, to a drive shaft, and with a secondary element which is torsionally elastically coupled to the primary element and which is connectible or connected, on an output side of the torsional vibration damper facing away from the drive side, to a transmission input shaft, and with a starter freewheel, via which the primary element can be indirectly or directly driven by a starter motor. The present invention furthermore relates to a drivetrain for a motor vehicle having such as freewheel-damper assembly.

Drivetrains with freewheel-damper assemblies within a motor vehicle are known in practice, which have a torsional vibration dampers and a starter freewheel, via which the drivetrain can be started using a starter motor. The torsional vibration dampers have a primary element, which is connectible or connected, on a drive side of the torsional vibration damper, to a drive shaft of an internal combustion engine, and a secondary element which is torsionally elastically coupled to the primary element and which is connected, on an output side of the torsional vibration damper facing away from the drive side, to a transmission input shaft of a transmission. The starter freewheel, via which the primary element can be indirectly or directly driven by the starter motor, is arranged on the drive side of the torsional vibration damper between the torsional vibration damper and the internal combustion engine.

The known freewheel-damper assemblies have proved successful, but there is nonetheless room for improvement since they generate high production, assembly and installation space costs.

Therefore, it is an object of the present invention to further develop a freewheel-damper assembly of the generic type so that it causes lower production costs, ensures simple assembly and has a reduced installation space requirement. Another object of the present invention is to produce a drivetrain for a motor vehicle which has such an advantageous freewheel-damper assembly.

This object is solved by the features stated in claims 1 and 10. Advantageous embodiments of the invention are the subject matter of the dependent claims.

The freewheel-damper assembly according to the invention for a motor vehicle has a torsional vibration damper. The torsional vibration damper has a primary element, which is connectible or connected, on a drive side of the torsional vibration damper, to a drive shaft, and a secondary element which is torsionally elastically coupled to the primary element and which is connectible or connected, on an output side of the torsional vibration damper facing away from the drive side, to a transmission input shaft. The drive shaft is preferably the output side of a crank shaft of an internal combustion engine to which the primary element is indirectly or directly connectible or connected. The drive side of the torsional vibration damper preferably designates the region, with respect to the axial direction, which is formed between the torsional vibration damper and a drive unit or an internal combustion engine or the housing thereof. Correspondingly, the output side of the torsional vibration damper facing away from the drive side designates the region, with respect to the axial direction, which is formed between the torsional vibration damper and a transmission or transmission housing. Furthermore, the freewheel-damper assembly has a starter freewheel via which the primary element can be indirectly or directly driven by a starter motor. The starter motor is preferably an electric motor or an electric machine. In order to have a reduced production and assembly cost, the starter freewheel is arranged on the output side of the torsional vibration damper. It has been shown that the arrangement of the starter freewheel on the output side of the torsional vibration damper makes it possible to reduce the required installation space for the freewheel-damper assembly. Furthermore, in the freewheel-damper assembly according to the invention, the starter freewheel can for example be provided in a module with the transmission or the transmission housing. The same also applies for the starter motor, which for example can be arranged or fastened on the transmission or transmission housing.

In order to reduce the radial installation space required for the freewheel-damper assembly, in a preferred embodiment of the freewheel-damper assembly according to the invention, the starter freewheel is arranged at least partially aligned with the torsional vibration damper in the axial direction.

Against the background of achieving a particularly compact construction of the freewheel-damper assembly, in an advantageous embodiment of the freewheel-damper assembly according to the invention, the starter freewheel is arranged at least partially in the axial direction between the torsional vibration damper and a transmission or transmission housing of the transmission input shaft.

In a further preferred embodiment of the freewheel-damper assembly according to the invention, the starter motor, which is preferably an electric motor or an electric machine, is arranged on the transmission housing in order to achieve as short as possible a torque transmission path between the output side of the starter motor and the input side of the starter freewheel.

In order to achieve secure and space-saving support of the starter freewheel, in particular in a starter motor arranged on the transmission housing, the starter freewheel, optionally a first raceway of the starter freewheel, is supported on the transmission housing via a radial bearing. The radial bearing is preferably a rolling bearing or a plain bearing. Said raceway of the starter freewheel is preferably the first raceway of the starter freewheel, described in more detail below. Moreover, it is preferred if the radial bearing is also designed as an axial bearing, or an axial bearing is further assigned to the radial bearing for the axial mounting of the first raceway.

In a further advantageous embodiment of the freewheel-damper assembly according to the invention, in order to support the starter freewheel on the transmission housing, the radial bearing is arranged in the axial direction between the transmission housing and the torsional vibration damper. In this embodiment, it is furthermore preferred if the axial bearing is arranged aligned with the transmission housing and the torsional vibration damper in the axial direction. In any case, this embodiment makes it possible to achieve a particularly compact and space-saving construction.

In a further preferred embodiment of the freewheel-damper assembly according to the invention, the starter freewheel has a first raceway which can be driven by the starter motor, and a second raceway which is assigned to the primary element, between which raceways clamping elements are arranged. Here, the first raceway preferably forms the abovementioned raceway which is supported or supportable on the transmission housing via the radial bearing. In principle, any clamping bodies that prevent clamping during a relative rotation between first and second raceway in one relative direction of rotation and enable clamping in the opposite relative direction of rotation can be used as clamping elements. However, it is preferred here if the clamping elements are designed as clamping rollers, thus particularly preferably if they have a circular circumference.

In a further advantageous embodiment of the freewheel-damper assembly according to the invention, the abovementioned clamping elements are arranged nested in the radial direction with the first and second raceways. Alternatively or additionally, the clamping elements can be supported on the first and second raceway in order to achieve the desired clamping effect in a predetermined relative direction of rotation between the two raceways. In any case, both the radial nesting of first and second raceway and the supportability of the clamping elements on both the first and on the second raceway achieves a particular compact construction in terms of the axial extent of the starter freewheel. In the latter variant, it is moreover preferred if the clamping elements can be supported directly on the first and second raceway, therefore not via optional side walls via which the clamping elements would be indirectly supported on one of the two raceways.

In a further advantageous embodiment of the freewheel-damper assembly, the torsional vibration damper has spring elements for the torsional elastic coupling of primary element and secondary element. The spring elements may for example be helical springs, wherein the helical springs may be designed as straight springs or bent springs.

According to a further advantageous embodiment of the freewheel-damper assembly according to the invention, the spring elements are accommodated in a spring receiving space of the primary element designed as a damper shell. Thus, it is in particular preferred if the damper shell is composed of two damper half shells which surround the spring receiving space located therebetween. The secondary element, on the other hand, is preferably flange-like, therefore designed as a damper flange, in order to be able to engage in a particularly simple manner in the spring receiving space and between the spring elements within the spring receiving space of the damper shell.

In order to achieve a starter freewheel which is constructed in a particularly compact manner in terms of the axial extent thereof, a relatively large diameter of the starter freewheel, and a plurality of clamping elements which each only have to transmit a small portion of the torque, are advantageous. Against this background, in a further advantageous embodiment of the freewheel-damper assembly according to the invention, the clamping elements are arranged aligned with the spring elements of the torsional vibration damper in the axial direction. Alternatively or additionally, the second raceway of the starter freewheel is aligned with the spring elements of the torsional vibration damper in the axial direction in order to achieve a particularly large diameter of the starter freewheel, which in turn enables the use of raceways and clamping elements which are designed to be of particularly small construction in the axial direction.

In a further advantageous embodiment of the freewheel-damper assembly according to the invention, the second raceway is in rotary driving connection with the primary element, bypassing the secondary element. Bypassing the secondary element should be understood here to mean that a torque of the second raceway is not transmitted to the primary element via the secondary element, and vice versa. In principle, in this embodiment, the second raceway can be in direct rotary driving connection to the primary element or be fastened thereto; however, it is preferred if a torque transmission element is provided between the second raceway and the primary element and is fastened via a fastening device to the primary element. In this way, the second raceway and the attachment to the primary element can be advantageously spaced apart from one another, in order to avoid having to adapt or restrict the installation space for adjacent components.

In a particularly preferred embodiment of the freewheel-damper assembly according to the invention, the second raceway is in rotary driving connection via the secondary element with the primary element, bypassing the transmission input shaft. Bypassing the transmission input shaft should be understood to mean that the transmission of a torque from the second raceway, via the secondary element, to the primary element, does not take place via the transmission input shaft. Similarly to the preceding embodiment, it is also preferred in this embodiment if a torque transmission element is provided, which in this embodiment extends between the second raceway and the secondary element. The torque transmission element is in turn fastened to the secondary element via a fastening device. Here, it has proven particularly advantageous if the torque transmission element is fastened via the fastening device to an output hub of the secondary element, which output hub is connectible or connected to the transmission input shaft in a rotationally fixed manner, wherein the output hub is preferably connectible or connected to the transmission input shaft via a releasable axial plug-in connection.

In a further particularly preferred embodiment of the freewheel-damper assembly according to the invention, the second raceway is in rotary driving connection with the primary element via the transmission input shaft and the secondary element. Here, it is preferred if a torque transmission element is provided between the second raceway and the transmission input shaft, wherein the torque transmission element is fastened to the transmission input shaft via a fastening device.

In further preferred particularly advantageous embodiments of the freewheel-damper assembly according to the invention, the abovementioned torque transmission element is releasably fastened via the fastening device to the primary element or the secondary element or the transmission input shaft. In other words, with the torque transmission element extending between second raceway and primary element, the torque transmission element is releasably fastened to the primary element, with the torque transmission element extending between the second raceway and the secondary element, the torque transmission element is fastened to the secondary element or the output hub of the secondary element, and with the torque transmission element extending between second raceway and transmission input shaft, the torque transmission element is releasably fastened to the transmission input shaft via the fastening device. In said cases, a fastening device which is designed as a releasable axial plug-in connection and proven particularly advantageous in order to achieve particularly simple assembly and disassembly. In order furthermore to effect a secure rotationally fixed connection between the parts connected via the fastening device, the releasable axial plug-in connection is particularly preferably designed as a releasable plug-in toothing.

According to a further advantageous embodiment of the freewheel-damper assembly according to the invention, the torque transmission element is non-releasably fastened to the second raceway. This can be achieved for example via a rivet joint. This implementation variant of the non-releasable fastening of the torque transmission element on the second raceway is in particular advantageous if the torque transmission element is releasably fastened on the other side on the primary element, the secondary element or the transmission input shaft. However, should this not be the case, a releasable fastening of the torque transmission element on the second raceway would in principle be advantageous.

According to a further preferred embodiment of the freewheel-damper assembly according to the invention, the fastening device is spaced apart from the second raceway, optionally also from the clamping elements, in the radial direction, preferably in the radial direction inwards, in order to achieve a compact construction of the freewheel-damper assembly in the region of the starter freewheel without the fastening device needing a large installation space in this region.

In a further advantageous embodiment of the freewheel-damper assembly according to the invention, the torque transmission element is designed as a sheet-metal part. The torque transmission element is also preferably designed as an annular or annular-disc-shaped sheet-metal part.

In a further preferred embodiment of the freewheel-damper assembly according to the invention, the sheet-metal part forming the torque transmission element is a sheet-metal part which is flexible in the axial direction, creating an axial clearance between the second raceway and the fastening device, such that the flexibility or resilience of the sheet-metal part in the axial direction enables a certain amount of clearance between the second raceway and the fastening device. In this embodiment, reference can also be made to a torque transmission element in the form of a flex plate.

The drivetrain according to the invention for a motor vehicle has a drive unit, preferably an internal combustion engine, a transmission and a freewheel-damper assembly of the type according to the invention, wherein the freewheel-damper assembly is arranged in the axial direction between the drive unit arranged on the drive side of the torsional vibration damper and the transmission arranged on the output side of the torsional vibration damper.

### BRIEF DESCRIPTION OF THE DRAWINGS

The invention is described in more detail below using exemplary embodiments with reference to the appended drawings. The drawings show:

FIG. 1 a cross-sectional view of a first embodiment of a freewheel-damper assembly within the drivetrain of a motor vehicle,

FIG. 2 a cross-sectional view of a second embodiment of a freewheel-damper assembly within a drivetrain of a motor vehicle, and

FIG. 3 a cross-sectional view of a third embodiment of a freewheel-damper assembly within the drivetrain of a motor vehicle.

### DETAILED DESCRIPTION

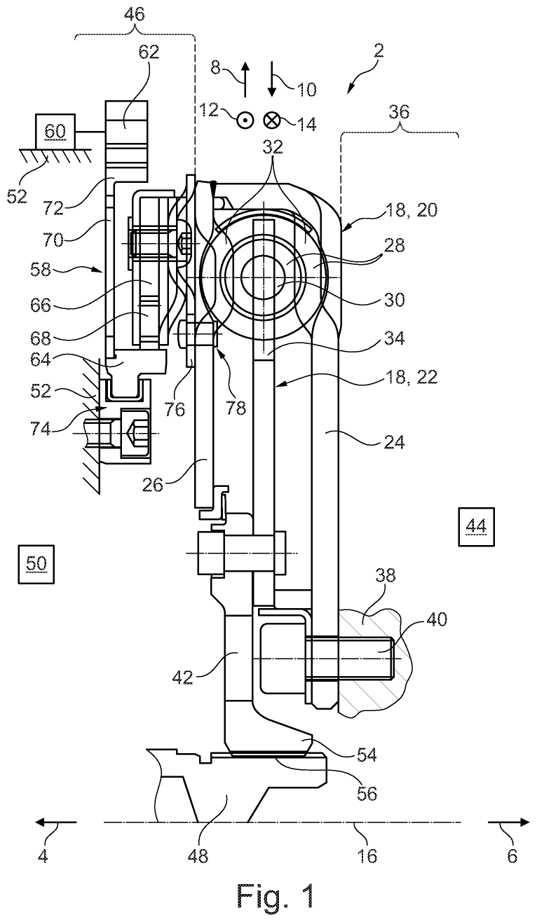

FIG. 1 shows a first embodiment of a freewheel-damper assembly 2 for a motor vehicle within the drivetrain of a motor vehicle. In FIG. 1, as also in the subsequent figures, the mutually opposed axial directions 4, 6, the mutually opposed radial directions 8, 10, and the mutually opposed circumferential directions 12, 14 of the freewheel-damper assembly 2 are indicated using corresponding arrows, wherein the essential constituents of the freewheel-damper assembly 2 are rotatable in the circumferential direction 12, 14 about an axis of rotation 16 extending in the axial directions 4, 6.

The freewheel-damper assembly 2 has a torsional vibration damper 18.

The torsional vibration damper 18 is substantially composed of a primary element 20 and a secondary element 22 which is torsionally elastically coupled to the primary element 20. The primary element 20 is formed by a damper shell which is composed of a first damper half shell 24 and a second damper half shell 26. For the torsionally elastic coupling of primary element 20 and secondary element 22, the torsional vibration damper 18 has spring elements 28, which are advantageously formed as helical springs in the illustrated embodiment. The spring elements 28 are accommodated in a spring receiving space 30 of the primary element 20 designed as a damper shell, which spring receiving space runs in the circumferential direction 12, 14, wherein rotary drivers 32 formed integrally with the two damper half shells 24, 26 protrude into the spring receiving space 30 in order to interact with the spring elements 28. The secondary element 22 is designed as a disc-shaped damper flange extending substantially in the radial directions 8, 10, wherein the secondary element 22 formed in this way also extends into the spring receiving space 30 with its rotary drivers 34 pointing outwards in the radial direction 8 in order to interact with the spring elements 28. The secondary element 22 in the form of the damper flange is substantially arranged in the axial direction 4, 6, between the two damper half shells 24, 26 lying opposite one another in the axial direction 4, 6.

The torsional vibration damper 18 has a drive side 36, which denotes the region next to the torsional vibration damper 18 in the axial direction 6. On this drive side 36 of the torsional vibration damper 18, the torsional vibration damper is connectible or connected to a drive shaft 38, in this case via a screw connection 40, which is accessible via a recess 42 in the secondary element 22 in the axial direction 6. The drive shaft 38 may be an end of the crank shaft of a drive unit 44, preferably of an internal combustion engine, with the drive unit 44 being arranged aligned with the torsional vibration damper 18 in the axial direction 6. Here, however, the torsional vibration damper 18 does not have to be directly connected or connectible to the drive shaft 38; rather, other torque transmission elements of the drivetrain may also be provided between the drive shaft 38 and the primary element 20 of the torsional vibration damper 18, and therefore it is possible to produce an indirect connectibility or connection between the primary element 20 and the drive shaft 38 of the drive unit 44.

Moreover, the torsional vibration damper 18 has an output side 46 facing away from the drive side 36, which denotes the region next to the torsional vibration damper 18 in the axial direction 4. On the output side 46, the secondary element 22 of the torsional vibration damper 18 is connectible or connected to a transmission input shaft 48 of a transmission 50, with substantially the transmission input shaft 48 of the transmission 50, and also a part of the transmission housing 52, being depicted. More precisely, the secondary element 22 in the form of the damper flange is connected to the transmission input shaft 48 in the radial direction 10 inwards via an output hub 54 of the secondary element 22, which output hub is connectible or connected to the transmission input shaft 48 in a rotationally fixed manner. The output hub 54 is connected via a releasable axial plug-in connection 56, more precisely via a plug-in toothing, to the transmission input shaft 48 in a rotationally fixed manner.

Furthermore, the freewheel-damper assembly 2 has a starter freewheel 58 via which the primary element 20, in the form of the damper shell, can be indirectly or directly driven by a starter motor 60. The starter motor 60, depicted merely schematically in FIG. 1, is designed as an electric motor or electric machine and has an output side in the form of a pinion 62. The starter motor 60 is arranged on the output side 46, more precisely at the transmission housing 52 of the transmission 50. The starter freewheel 58 is also arranged on the output side 46 of the torsional vibration damper 18. More precisely, the starter freewheel 58 is at least partially, in the illustrated embodiment entirely, arranged aligned with the torsional vibration damper 18 in the axial direction 4, 6 and arranged between the torsional vibration damper 18 and the transmission 50 or the transmission housing 52 of the transmission 50 in the axial direction 4, 6.

The starter freewheel 58 has—based on the starter motor 16—a first raceway 64 on the input side in the radial direction 10, which first raceway is designed as an internal raceway 64 in the radial direction 10, and—based on the the starter motor—a second raceway 66 on the output side, which second raceway is designed as an external raceway 66 in the radial direction 8. Therefore, the first raceway 64 can be driven by the starter motor 60, while the second raceway 66 is assigned to the primary element 20 of the torsional vibration damper 18. The first and second raceway 64, 66 are arranged nested in the radial direction 8, 10 and therefore the external second raceway 66 outwardly surrounds the internal first raceway 64 in the radial direction 8, wherein clamping elements 68, here as clamping rollers with circular outer circumference, are arranged between the raceways 64, 66 in the radial direction 8, 10. The first raceway 64, the second raceway 66 and the clamping elements 68 are arranged nested in the radial direction. The clamping elements 68 are also supportable or supported on the surface of the first raceway 64 which faces outwards in the radial direction 8 and on the surface of the second raceway 66 which faces inwards in the radial direction 10. Moreover, both the clamping elements 68 and the second raceway 66 of the starter freewheel 58 are arranged aligned with the spring elements 28 of the torsional vibration damper 18 in the axial direction 4, 6.

In the axial direction 4 next to the clamping elements 68 and the second raceway 66, a torque transmission member 70 extends substantially in the radial direction 8, 10. The substantially annular-disc-shaped torque transmission member 70 is fastened in the radial direction 10 inwards to the first raceway 64 in a rotationally fixed manner, in order to extend from that point in the radial direction 8 outwards to a gear rim 72 of the starter freewheel 58, in which gear rim the pinion 62 of the starter motor 60 engages, in order to be able to drive the first raceway 64 by the starter motor 60 via the torque transmission member 70. The first raceway 64 is rotatably supported and mounted via a radial bearing 74 on the transmission housing 52 both in the radial direction 8, 10 and in the axial directions 4, 6, wherein the radial bearing 74, which also acts here as an axial bearing, being designed as a plain bearing. Alternatively, the radial bearing 74 could however also advantageously be formed from a rolling bearing. In any case, the radial bearing 74 is arranged between the transmission housing 52 and the torsional vibration damper 18 in the axial direction 4, 6 and aligned with same in the axial direction 4, 6.

As already indicated above, the second raceway 66 is assigned indirectly or directly to the primary element 20 of the torsional vibration damper, that is to say that a torque of the second raceway 66 of the starter freewheel 58 can be indirectly or directly transmitted to the primary element 20 of the torsional vibration damper 18. To this end, a torque transmission element 76 is provided, which extends between the second raceway 66 and the primary element 20, more precisely the second damper half shell 26 of the primary element designed as a damper shell, wherein the torque transmission element 76 is fastened on one side in a rotationally fixed manner to the second raceway 66 and on the other side via a fastening device 78 to the second damper half shell 76 of the primary element 20. Therefore, in the first embodiment shown in FIG. 1, the second raceway 66 is in rotary driving connection with the primary element 20, bypassing the secondary element 22, and therefore a torque of the second raceway 66 is transmitted to the primary element 20, not via the secondary element 22. The torque transmission element 76 is designed here as a sheet-metal part. Here, it is preferred if the torque transmission element 76 is designed as a sheet-metal part which is flexible in the axial direction, forming an axial clearance between the second raceway and the fastening device 78, and therefore is designed as a flex plate.

In the illustrated embodiment, the torque transmission element 76 is non-releasably fastened via the fastening device 78, here by means of a rivet connection, to the primary element 20, more precisely the second damper half shell 76 of the primary element 20. Although not illustrated, it can therefore be advantageous here if the torque transmission element 76 is releasably fastened via the fastening device 78 to the primary element 20. In these alternative configuration variants, the fastening device 78 is preferably designed as a releasable axial plug-in connection, particularly preferably a releasable plug-in toothing, which would be provided between the primary element 20 and the torque transmission element 76. These alternative embodiment variants would therefore ensure that a particularly simple assembly and disassembly could be achieved along a module dividing or joining line between the torque transmission element 76 and the primary element 20 of the torsional vibration damper 18. In this case, the torque transmission element 76 can also advantageously be non-releasably fastened to the second raceway 66 or even be integrally formed therewith, which would reduce the number of parts without increasing the assembly cost. Regardless of the selection of the respective variants, the fasting device 78 is arranged spaced apart from the second raceway 66 of the starter freewheel 58 in the radial direction 8, 10, here advantageously in the radial direction 10 inwards.

In the first embodiment according to FIG. 1, in order to start the drive unit 44 by the starter motor 60, there is a torque transmission via the pinion 62, the gear rim 72, the torque transmission member 70, the first raceway 64, the clamped clamping elements 68, the second raceway 66, the torque transmission element 76, the second damper half shell 26 of the primary element 20 and the first damper half shell 24 of the primary element 20 onto the drive shaft 38 or onto the further components of the drivetrain which are in rotary driving connection with the drive shaft 38.

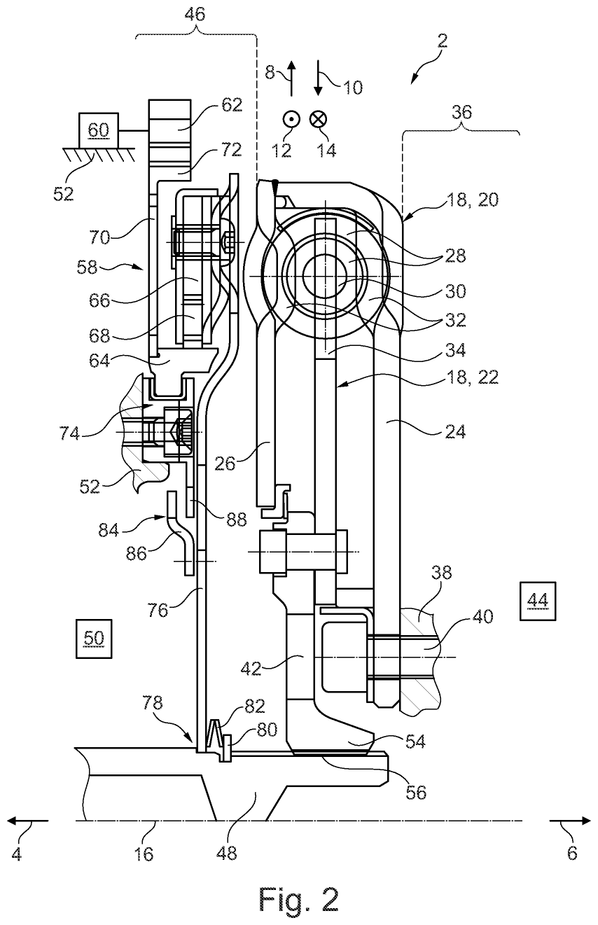

FIG. 2 shows a second embodiment of the freewheel-damper assembly 2 or of a drivetrain of the motor vehicle having such a freewheel-damper assembly 2, which corresponds substantially to the freewheel-damper assembly 2 according to FIG. 1, and therefore hereinafter only the differences will be discussed, the same reference signs will be used for identical or similar parts, and the above description also applies accordingly.

In the second embodiment according to FIG. 2, the second raceway 66 is in rotary driving connection with the primary element 20 of the torsional vibration damper 18 via the transmission input shaft 16 and the secondary element 22 of the torsional vibration damper 18. To this end, the torque transmission element 76, already described above, is also provided. In contrast to the first embodiment, however, the torque transmission element 76 extends further in the radial direction 10 inwards, in order to be arranged between the second raceway 66 on one side and the transmission input shaft 48 of the transmission 50 on the other side. Therefore, the abovementioned fastening device 78 is not designed to be between the torque transmission element 76 and the primary element 20, but rather between the torque transmission element 76 and the transmission input shaft 48, wherein the torque transmission element 76 is fastened via the fastening device 78 to the transmission input shaft 48 in a rotationally fixed manner. As already indicated above, in the second embodiment according to FIG. 2, the fastening device 78 is a releasable axial plug-in connection, more precisely a plug-in toothing, between the torque transmission element 76 and the transmission input shaft 48. Thus, the torque transmission element 76, with a toothing pointing inwards in the radial direction 10, is simply fitted in the axial direction 4 onto an outer toothing on the transmission input shaft 48, in order to achieve a rotationally fixed connection via the fastening device 78 between torque transmission element 76 and transmission input shaft 48. Furthermore, the torque transmission element 76 is supportable or supported on the transmission input shaft 78 following the sliding in the axial direction 6, wherein, to this end, a circlip 80 is arranged on the transmission input shaft 48. In order to enable a certain amount of axial clearance between the fastening device 78 and the transmission input shaft 48, the torque transmission element 76 and the circlip 80 can be supported against one another via a spring element 82, preferably a cup spring, in the axial direction 4, 6. This has the advantage that the torque transmission element 76 itself—as described with reference to FIG. 1—does not necessarily, or not to a significant extent, have to be designed as a flexible sheet-metal part which is flexible in the axial direction in the sense of a flex plate, although this may alternatively or additionally be advantageous.

In the freewheel-damper assembly 2, if the drive unit 44 is started by the starter motor 60, the torque transmission takes place via the pinion 62, the gear rim 72, the torque transmission member 70, the first raceway 64, the clamping elements 68 clamped between first and second raceway 64, 66, the second raceway 66, the torque transmission element 76, the transmission input shaft 48, the secondary element 22 and the primary element 20 on the drive shaft 38 or any further components of the drivetrain which may be present and are in rotary driving connection with the drive shaft 38. The connection of the torque transmission element 76 to the transmission input shaft makes it possible to achieve a clear separation between the module of the starter freewheel 58 and of the transmission 50 on one side and the module of the torsional vibration damper 18 and the drive unit 44 on the other side, which separation enables particularly simple assembly and disassembly of said modules with one another or from one another. The output hub 54 of the secondary element 22 of the torsional vibration damper 18, which is to be fastened to the transmission input shaft 48 via a plug-in toothing 56, also makes a decisive contribution to this. In any case, the transmission 50 together with transmission housing 52 and transmission input shaft 48, the starter motor 60, the starter freewheel 58 and the torque transmission element 76 can form a contiguous module which can be provided independently of the drive unit and the torsional vibration damper 18, which module is connected at a later point in time to the torsional vibration damper 18 and the drive unit 44 in the context of the assembly, with the torsional vibration damper 18 and the drive unit 44 being able to already form a pre-assembled contiguous module. It may also be advantageous, for reducing the number of parts, if the torque transmission element 76 is non-releasably fastened to the second raceway 66 of the starter freewheel 58, whether by a rivet connection or by being integrally formed therewith; however, it is also possible—as shown in FIG. 2—for the torque transmission element 76 to be releasably fastened to the second raceway 66 of the starter freewheel 58.

Finally, it should be mentioned in relation to the second embodiment 2 that an axial securing retainer 84 can be assigned to the torque transmission element 76 alternatively or additionally to the circlip 80. In the illustrated second embodiment, such an axial securing retainer 84 has a retaining part 86 fastened on the torque transmission element 76, which retaining part engages behind a retaining part 88 fastened on the transmission housing, such that the retaining part 86 is supportable or supported on the retaining part 88 in the axial direction 6. The transmission housing-side retaining part 88 is preferably designed as a constituent of the abovementioned radial bearing or axial bearing 74, as can be seen in FIG. 2. The retaining part 88 serves both for supporting the torque transmission element 76 in the axial direction 6 on the transmission housing and for supporting the first raceway 64 in said axial direction 6, with the retaining part 88 being releasably and/or directly or indirectly connected to the transmission housing 52.

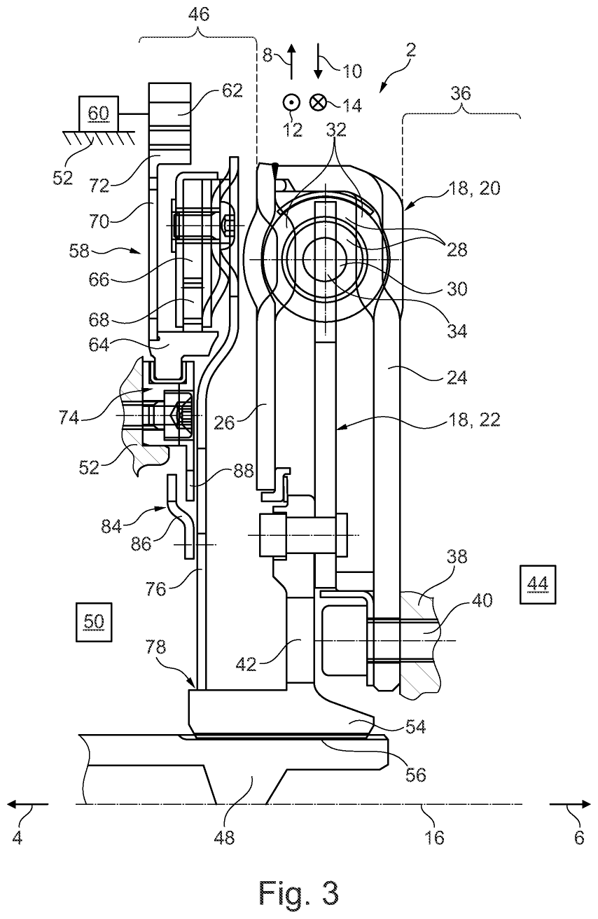

FIG. 3 shows a third embodiment of the freewheel-damper assembly 2, which corresponds substantially to the embodiment according to FIG. 2, and therefore hereinafter only the differences will be discussed, the same reference signs will be used for identical or similar parts, and the above description also applies accordingly.

In the third embodiment according to FIG. 3, the second raceway 66 of the starter freewheel 58 is in rotary driving connection with the primary element 20 of the torsional vibration damper 18 via the secondary element 22, bypassing the transmission input shaft 48. To this end, in turn, the torque transmission element 76, already described above with reference to the first two embodiments, is provided, wherein, in the third embodiment, the torque transmission element extends between the second raceway 66 and the secondary element 22, and therefore a torque of the second raceway 66 can be transmitted to the primary element 20, not via the transmission input shaft 48. More precisely, the torque transmission element 76 is fastened via the fastening device 78 to the output hub 54 of the secondary element 22, which output hub is connectible or connected to the transmission input shaft 48 in a rotationally fixed manner. The fastening device 78 in turn forms a releasable axial plug-in connection with the output hub 54 of the secondary element 22, which plug-in connection is in turn preferably the plug-in toothing shown in FIG. 3. In other words, a toothing is provided on the side of the output hub 54 which faces outwards in the radial direction 8, into which toothing the toothing provided on the side of the torque transmission element 76 which faces inwards in the radial direction 10 engages in order to form the fastening device 78 in the form of the plug-in toothing. Although the circlip 80 already provided with reference to FIG. 2 could also be provided here on the output hub 54, optionally in conjunction with the spring element 82, in order to be able to support the torque transmission element 76 in the axial direction 4, 6 on the output hub 54, this is dispensed with in the embodiment shown in FIG. 3, and therefore the axial securing of the torque transmission element 76 or its support is assumed by the axial securing retainer 84 alone, while an axial clearance caused by the plug-in toothing is ensured between the torque transmission element 76 and the output hub.

The statements regarding the second embodiment according to FIG. 2 in relation to the assembly or disassembly also accordingly apply to the third embodiment, with the production of the plug-in connection being somewhat more complex, especially since both the plug-in toothing 56 between output hub 54 and transmission input shaft 48 and the plug-in toothing between output hub 54 and torque transmission element 76 must be produced in the region of the fastening device 78 during assembly, but in the third embodiment according to FIG. 3 this also gives a more compact construction of the freewheel-damper assembly 2. Alternatively, parts of the starter freewheel 58 could however form a contiguous module with the torsional vibration damper 18 by the torque transmission element 76 being secured on the output hub in the axial direction via the fastening arrangement 78. The module dividing or joining line would then run between the clamping elements 68 and the first raceway 64, between the output hub 54 and the transmission input shaft 48 and between the primary element 18 and the drive shaft 38. This can also apply correspondingly to the embodiment according to FIG. 1.

Finally, it should be mentioned regarding the third embodiment according to FIG. 3 that when the drive unit 44 is started by the starter motor 60, a torque can be transmitted via the pinion 62, the gear rim 72, the torque transmission member 70, the first raceway 64, the clamping elements 68 clamped between first and second raceway 64, 66, the second raceway 66, the torque transmission element 76, the secondary element 22 and the primary element 20 on the drive shaft 38 or the components of the drivetrain assembled before the drive shaft 38, which are in rotary driving connection with the drive shaft 38.

### LIST OF REFERENCE SIGNS

2 Freewheel-damper assembly
4 Axial direction
6 Axial direction
8 Radial direction
10 Radial direction
12 Circumferential direction
14 Circumferential direction
16 Axis of rotation
18 Torsional vibration damper
20 Primary element
22 Secondary element
24 First damper half shell
26 Second damper half shell
28 Spring elements
30 Spring receiving space
32 Rotary driver
34 Rotary driver
36 Drive side
38 Drive shaft
40 Screw connection
42 Recess
44 Drive unit
46 Output side
48 Transmission input shaft
50 Transmission
52 Transmission housing
54 Output hub
56 Axial plug-in connection
58 Starter freewheel
60 Starter motor
62 Pinion
64 First raceway
66 Second raceway
68 Clamping elements
70 Torque transmission member
72 Gear rim
74 Radial bearing
76 Torque transmission element
78 Fastening device
80 Circlip
82 Spring element
84 Axial securing retainer
86 Retaining part
88 Retaining part

1. A freewheel-damper assembly (2) for a motor vehicle, having a torsional vibration damper (18) with a primary element (20) which is connectible or connected, on a drive side (36) of the torsional vibration damper (18), to a drive shaft (38), and with a secondary element (22) which is torsionally elastically coupled to the primary element (20) and which is connectible or connected, on an output side (46) of the torsional vibration damper (18) facing away from the drive side (36), to a transmission input shaft (48), and with a starter freewheel (58), via which the primary element (20) can be indirectly or directly driven by a starter motor (60), wherein the starter freewheel (58) is arranged on the output side (46) of the torsional vibration damper (18).

2. The freewheel-damper assembly (2) according to claim 1, wherein the starter freewheel (58) is arranged at least partially aligned with the torsional vibration damper (18) in the axial direction (4, 6) and/or between the torsional vibration damper (18) and a transmission (50) or transmission housing (52) of the transmission input shaft (48).

3. The freewheel-damper assembly (2) according to claim 2, wherein the starter motor (60) is arranged on the transmission housing (52) and/or the starter freewheel (58), optionally a raceway (64) of the starter freewheel (58), is supported on the transmission housing (52) via a radial bearing (74), preferably a rolling bearing or a plain bearing, which bearing is particularly preferably arranged in the axial direction between the transmission housing (62) and the torsional vibration damper (18) and optionally arranged aligned with same in the axial direction (4, 6).

4. The freewheel-damper assembly (2) according to claim 1, wherein the starter freewheel (58) has a first raceway (64), which can be driven by the starter motor (60), and a second raceway (66), which is assigned to the primary element (20) and between which raceways clamping elements (68), preferably clamping rollers, are arranged, which are particularly preferably arranged nested in the radial direction (8, 10) with the first and second raceways (64, 66) and/or can be supported, optionally directly, on the first and second raceways (64, 66).

5. The freewheel-damper assembly (2) according to claim 1, wherein the torsional vibration damper (18) has spring elements (28) for the torsional elastic coupling of primary element (20) and secondary element (22), wherein the spring elements (28) are preferably accommodated in a spring receiving space (30) of the primary element (20) designed as a damper shell, while the secondary element (22) is particularly preferably designed as a damper flange, wherein the clamping elements (68) and/or the second raceway (66) is/are optionally arranged aligned with the spring elements (28) in the axial direction (4, 6).

6. The freewheel-damper assembly (2) according to claim 1, wherein the second raceway (66) is in rotary driving connection with the primary element (20), bypassing the secondary element (22), wherein a torque transmission element (76) is preferably provided between the second raceway (66) and the primary element (20) and is fastened to the primary element (20) via a fastening device (78).

7. The freewheel-damper assembly (2) according to claim 1, wherein the second raceway (66) is in rotary driving connection via the secondary element (22) with the primary element (20), bypassing the transmission input shaft (48), wherein a torque transmission element (76) is preferably provided between the second raceway (66) and the secondary element (22) and is fastened via a fastening device (78) to the secondary element (22), particularly preferably to an output hub (54) of the secondary element (22), which output hub is connectible or connected to the transmission input shaft (48) in a rotationally fixed manner and is optionally connected to the transmission input shaft (48) via a releasable axial plug-in connection (56).

8. The freewheel-damper assembly (2) according to claim 1, wherein the second raceway (66) is in rotary driving connection with the primary element (20) via the transmission input shaft (48) and the secondary element (22), wherein a torque transmission element (76) is preferably provided between the second raceway (66) and the transmission input shaft (48) and is fastened to the transmission input shaft (48) via a fastening device (78).

9. The freewheel-damper assembly (2) according to claim 6, wherein the torque transmission element (76) is releasably fastened via the fastening device (78) to the primary element (20), the secondary element (22) or the transmission input shaft (48), wherein the fastening device (78) is preferably a releasable axial plug-in connection, particularly preferably a releasable plug-in toothing, and/or the torque transmission element (78) is non-releasably fastened to the second raceway and/or the fastening device (78) is spaced apart from the second raceway (66) in the radial direction (8, 10), preferably in the radial direction (10) inwards, and/or the torque transmission element (76) is a sheet-metal part, preferably a sheet-metal part which is flexible in the axial direction (4, 6), creating an axial clearance between the second raceway (66) and the fastening device (78).

10. A drivetrain for a motor vehicle, having a drive unit (44), a transmission (50) and a freewheel-damper assembly (2) according to claim 1 in the axial direction (4, 6) between the drive unit (44) on the drive side (36) and the transmission (50) on the output side (46).
